(19) United States
(12) Patent Application Publication
(10) Pub. No.: US 2024/0014524 A1
(43) Pub. Date: Jan. 11, 2024

(54) POWER STORAGE MODULE AND METHOD OF PRODUCING POWER STORAGE MODULE

(71) Applicant: Toyota Jidosha Kabushiki Kaisha, Toyota-shi Aichi-ken (JP)

(72) Inventors: Hiroyuki NAKAYAMA, Okazaki-shi Aichi-ken (JP); Shintaro YAMAOKA, Kariya-shi Aichi-ken (JP); Kazuhiro NIIMURA, Kariya-shi Aichi-ken (JP); Takayuki HIROSE, Kariya-shi Aichi-ken (JP); Fumihiko ISHIGURO, Kariya-shi Aichi-ken (JP)

(73) Assignee: Toyota Jidosha Kabushiki Kaisha, Toyota-shi Aichi-ken (JP)

(21) Appl. No.: 18/212,736

(22) Filed: Jun. 22, 2023

(30) Foreign Application Priority Data
Jul. 6, 2022 (JP) 2022-109046

(51) Int. Cl. H01M 50/553; H01M 50/54; H01M 50/486; H01M 50/176; H01M 50/569; H01M 50/474

(52) U.S. Cl. CPC H01M 50/553; H01M 50/54; H01M 50/486; H01M 50/176; H01M 50/569; H01M 50/474; H01M 2004/029

(57) ABSTRACT

A power storage module comprises an electrode assembly including a plurality of electrode plates stacked in a stacking direction, a resin sealing body for sealing an internal space formed between two adjacent electrode plates of the plurality of electrode plates, and a terminal member provided to the electrode assembly so as to protrude from the resin sealing body toward outside, wherein the terminal member is provided with one or more through holes penetrating along the stacking direction.

### CROSS REFERENCE TO RELATED APPLICATIONS

This nonprovisional application is based on Japanese Patent Application No. 2022-109046 filed on Jul. 6, 2022, with the Japan Patent Office, the entire contents of which are hereby incorporated by reference.

### BACKGROUND OF THE DISCLOSURE

### Field of the Disclosure

The present disclosure relates to a power storage module and a method of producing a power storage module.

### Description of the Background Art

In recent years, information-related apparatuses and communication apparatuses such as personal computers and mobile phones have become more and more popular, and along with this rapid trend, various batteries for use as the power supply have been being developed. Also in automobile industry, batteries of high power and high capacity for use in electric vehicles or hybrid electric vehicles have been being developed.

As a conventional power storage module, Japanese Patent Laying-Open No. 2020-119633 discloses a technique that involves sealing the side surface of an electrode assembly formed of stacking of a positive electrode and a negative electrode, with a resin sealing body in a manner that a current collector layer protrudes from the resin sealing body toward outside. As the resin for constituting the resin sealing body, a hot-melt agent, a thermosetting resin, and/or an ultraviolet-curable resin is used.

### SUMMARY OF THE DISCLOSURE

So as to cure resin to form a resin sealing body as in Japanese Patent Laying-Open No. 2020-119633, placing the resin on the side surface of the electrode assembly so that the current collector layer protrudes from the resin toward outside and then applying ultraviolet light or infrared light toward the resin can be considered, for example.

When ultraviolet light or infrared light is applied along a direction parallel to a protruding direction (which is a direction in which the current collector layer protrudes) in the plan view of the electrode assembly, toward the resin thus placed on the side surface of the electrode assembly, if the current collector layer is tilted, it is difficult to irradiate, with ultraviolet light or infrared light, a portion of the resin that is positioned in a region overlapping the current collector layer in the direction parallel to the protruding direction. In such a case, the portion of the resin that is positioned in a region overlapping the protruding current collector layer may not be sufficiently cured.

The present disclosure has been devised in light of the above-described problem, and an object of the present disclosure is to provide a power storage module, and a method of producing the power storage module, that is capable of reducing failures in sealing the internal space formed between two adjacent electrode plates with a resin sealing body.

A power storage module according to the present disclosure comprises an electrode assembly including a plurality of electrode plates stacked in a stacking direction, a resin sealing body for sealing an internal space formed between two adjacent electrode plates of the plurality of electrode plates, and a terminal member provided to each of the plurality of electrode plates so as to protrude from the resin sealing body toward outside. A portion of the terminal member protruding from the resin sealing body is provided with one or more through holes penetrating along the stacking direction.

With the above-described configuration, even when the terminal member is tilted relative to the main face of the electrode plate, it is possible to irradiate, with infrared light or ultraviolet light, a resin member, which is a precursor of the resin sealing body, through the one or more through holes. By this, as compared to when no through hole is provided to the terminal member, even at a region overlapping the tilted terminal member, it is possible to facilitate welding or curing of the resin member, allowing for reducing failures in sealing with the resin sealing body.

In the power storage module according to the present disclosure, the one or more through holes may be configured in the form of a plurality of slits.

With the above-described configuration, it is possible to irradiate the resin member, which is a precursor of the resin sealing body, with infrared light or ultraviolet light through the plurality of slits, allowing for reducing failures in sealing with the resin sealing body.

In the power storage module according to the present disclosure, the plurality of slits, when viewed in the stacking direction, may be aligned either in a protruding direction in which the terminal member protrudes from the resin sealing body, or in a direction crossing the protruding direction.

With the above-described configuration, it is possible to irradiate the resin member, which is a precursor of the resin sealing body, with infrared light or ultraviolet light through the plurality of slits aligned in the protruding direction or in the direction crossing the protruding direction, allowing for reducing failures in sealing with the resin sealing body.

In the power storage module according to the present disclosure, the plurality of slits may be provided so as to, when viewed in the stacking direction, extend along a protruding direction in which the terminal member protrudes from the electrode assembly and also be aligned in a direction crossing the protruding direction. In this case, each end of the plurality of slits that is located closer to the electrode assembly in the protruding direction may be embedded inside the resin sealing body.

With the above-described configuration where each end of the plurality of slits is embedded inside the resin sealing body, it is possible to irradiate a portion where the resin member, which is a precursor of the resin sealing body, and the terminal member overlap one another in the stacking direction, with infrared light or ultraviolet light through the plurality of slits, allowing for reducing failures in sealing with the resin sealing body.

In the power storage module according to the present disclosure, a slit width of each of the plurality of slits may be twice a wavelength of infrared light or less. The slit width may include an error of several percent (%) caused by manufacturing error.

With the above-described configuration, due to the effect of diffraction, it is possible to irradiate a larger area of the resin member, which is a precursor of the resin sealing body, with infrared light, allowing for reducing failures in sealing with the resin sealing body.

In the power storage module according to the present disclosure, the electrode plate may be a bipolar electrode. In this case, the terminal member may be a voltage detection terminal for detecting voltage between the two adjacent electrode plates.

With the above-described configuration, when using a bipolar electrode as the electrode plate and providing the bipolar electrode with a voltage detection terminal, even at a region overlapping the tilted voltage detection terminal, it is possible to facilitate welding or curing of the resin member, allowing for reducing failures in sealing with the resin sealing body.

In the power storage module according to the present disclosure, the voltage detection terminal provided to one of the two adjacent electrode plates and the voltage detection terminal provided to the other one of the two adjacent electrode plates may be positioned in such a manner that overlapping is avoided when viewed in the stacking direction.

With the above-described configuration, in the case where at least one of the voltage detection terminal provided to one of the electrode plates and the voltage detection terminal provided to the other electrode plate is tilted, at the time of applying infrared light or ultraviolet light to the resin member, which is a precursor of the resin sealing body, it is possible to inhibit the shadow of the voltage detection terminal provided to one of the electrode plates and the shadow of the voltage detection terminal provided to the other electrode plate from overlapping one another. By this, it is possible to reduce regions that are hard to be reached by infrared light or ultraviolet light, allowing for reducing failures in sealing with the resin sealing body.

A method of producing a power storage module according to the present disclosure comprises placing a resin member for sealing an internal space formed between two adjacent electrode plates inside an electrode assembly including a plurality of electrode plates stacked in a stacking direction, and forming a resin sealing body by welding or curing the resin member. The placing a resin member includes placing the resin member in such a manner that a protruding portion provided with one or more through holes penetrating along the stacking direction protrudes from the resin member toward outside. The forming a resin sealing body includes applying infrared light or ultraviolet light toward the resin member along a direction parallel to a protruding direction in which the protruding portion protrudes when viewed in the stacking direction.

With the above-described configuration, even when the protruding portion is tilted relative to the main face of the electrode plate, it is possible to irradiate the resin member, which is a precursor of the resin sealing body, with infrared light or ultraviolet light through the one or more through holes. By this, as compared to when no through hole is provided to the protruding portion, even at a region overlapping the tilted protruding portion, it is possible to facilitate welding or curing of the resin member, allowing for reducing failures in sealing with the resin sealing body.

In the method of producing a power storage module according to the present disclosure, the protruding portion may include a terminal member provided to the electrode plate.

With the above-described configuration, even when the terminal member provided to each of the plurality of electrode plates is tilted, even at a region overlapping the tilted terminal member, it is possible to facilitate welding or curing of the resin member.

In the method of producing a power storage module according to the present disclosure, the electrode plate may be a bipolar electrode. In this case, the terminal member may be a voltage detection terminal for detecting voltage between the two adjacent electrode plates.

With the above-described configuration, when using a bipolar electrode plate as the electrode plate and providing the bipolar electrode with a voltage detection terminal, even at a region overlapping the tilted voltage detection terminal, it is possible to facilitate welding or curing of the resin member.

In the method of producing a power storage module according to the present disclosure, the protruding portion may include an inlet-forming jig located between the two adjacent electrode plates for forming an inlet from which an electrolyte solution is to be injected into the internal space.

With the above-described configuration, even when the inlet-forming jig for forming an inlet is tilted, even at a region overlapping the tilted jig, it is possible to facilitate welding or curing of the resin member.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a plan view of a power storage module according to Embodiment 1.

FIG. 2 is a side view of the power storage module viewed in the direction indicated by line II shown in FIG. 1.

FIG. 3 is a side view of the power storage module viewed in the direction indicated by line III shown in FIG. 1.

FIG. 4 is a cross-sectional view of the power storage module along line IV-IV shown in FIG. 2.

FIG. 5 is a flowchart of a production procedure for the power storage module according to Embodiment 1.

FIG. 6 is a schematic cross-sectional view of a step, in the production procedure shown in FIG. 5, to place a resin member in such a manner that the terminal member protrudes from the resin member.

FIG. 7 is a schematic cross-sectional view of a step, in the production procedure shown in FIG. 5, to place a resin member in such a manner that an inlet-forming jig protrudes from the resin member.

FIG. 8 is a schematic cross-sectional view of a step, in the production procedure shown in FIG. 5, to apply infrared light or ultraviolet light toward the resin member that is placed in such a manner that the terminal member protrudes from it.

FIG. 9 is a schematic view of the application step shown in FIG. 7 when the terminal member is tilted.

FIG. 10 is a schematic view of a step, in the production procedure shown in FIG. 5, to apply infrared light or ultraviolet light toward the resin member that is placed in such a manner that the inlet-forming jig protrudes from it.

FIG. 11 is a plan view of a power storage module according to a first modification.

FIG. 12 is a plan view of a power storage module according to a second modification.

FIG. 13 is a plan view of a power storage module according to a third modification.

FIG. 14 is a plan view of a power storage module according to a fourth modification.

FIG. 15 is a cross-sectional view of a power storage module according to Embodiment 2.

### DESCRIPTION OF THE EMBODIMENTS

A detailed description will be given of embodiments of the present disclosure, with reference to drawings. In the embodiments described below, the same or common members are denoted by the same reference numeral in the drawings, and description thereof will not be repeated. When there are a plurality of embodiments and modifications below, it is expected that the features of the embodiments and modifications can be combined as appropriate, unless otherwise specified.

### Embodiment 1

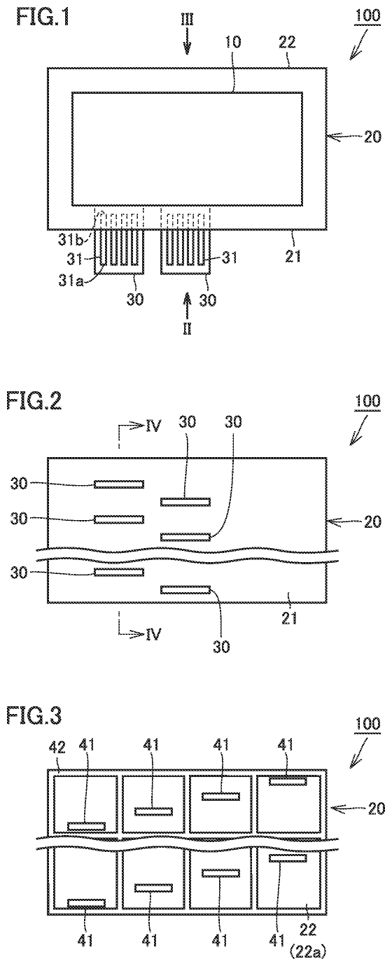

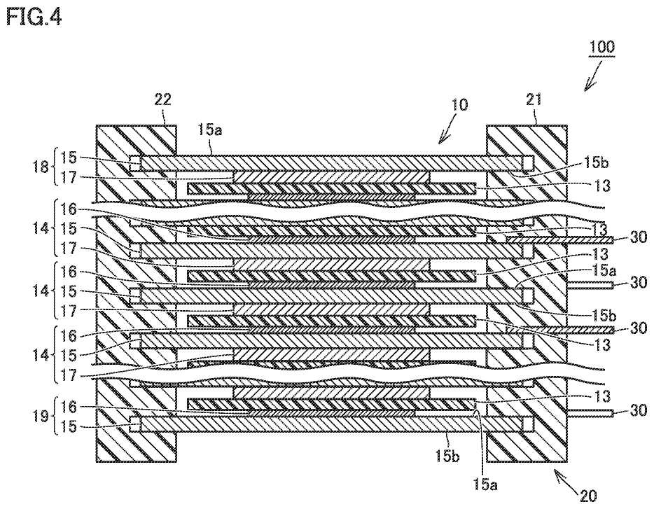

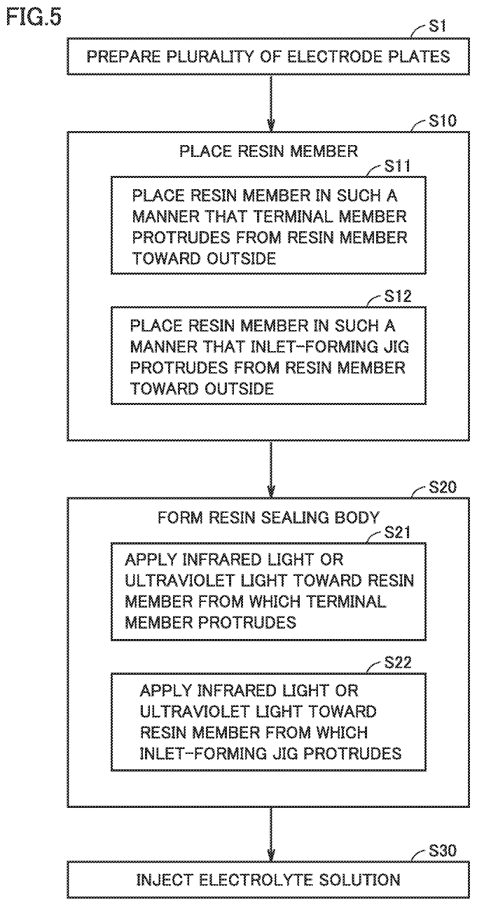

FIG. 1 is a plan view of a power storage module according to Embodiment 1. FIG. 2 is a side view of the power storage module viewed in the direction indicated by line II shown in FIG. 1. FIG. 3 is a side view of the power storage module viewed in the direction indicated by line III shown in FIG. 1. FIG. 4 is a cross-sectional view of the power storage module along line IV-IV shown in FIG. 2. With reference to FIG. 1 to FIG. 4, the power storage module according to Embodiment 1 will be described.

As illustrated in FIG. 1 to FIG. 4, a power storage module 100 according to Embodiment 1 comprises an electrode assembly 10 and a resin sealing body 20. Power storage module 100 is a so-called bipolar battery. For example, power storage module 100 is a secondary battery such as a lithium-ion secondary battery or a nickel-hydride secondary battery.

Electrode assembly 10 includes a plurality of electrode plates 14, a plurality of separators 13, a side-facing negative electrode 18, and a side-facing positive electrode 19. Electrode plates 14, side-facing negative electrode 18, and side-facing positive electrode 19 are stacked in the stacking direction, with separator 13 interposed between them.

Separator 13 is formed as a sheet. Examples of separator 13 include porous films made of polyolefin-based resins such as polyethylene (PE) and/or polypropylene (PP), woven fabrics or nonwoven fabrics made of polypropylene and/or methylcellulose, and the like. Separator 13 may be reinforced with a vinylidene difluoride resin compound.

Electrode plates 14 are interposed between side-facing negative electrode 18 and side-facing positive electrode 19. Each electrode plates 14 is a bipolar electrode, for example, and includes a metal plate 15, a positive electrode layer 16, and a negative electrode layer 17.

Metal plate 15 may include, for example, at least one selected from the group consisting of aluminum (Al), stainless steel, nickel (Ni), chromium (Cr), platinum (Pt), niobium (Nb), iron (Fe), titanium (Ti), and zinc (Zn). Metal plate 15 may have plating on the surface of the metal foil.

Metal plate 15 has a first main face 15a on one side in the stacking direction, and a second main face 15b on the other side in the stacking direction. First main face is provided with positive electrode layer 16. Second main face 15b is provided with negative electrode layer 17.

Side-facing negative electrode 18 configures an end of electrode assembly 10 on one side in the stacking direction. Side-facing negative electrode 18 includes metal plate 15 and negative electrode layer 17. Negative electrode layer 17 is provided to second main face 15b of metal plate 15. As for side-facing negative electrode 18, neither positive electrode layer 16 nor negative electrode layer 17 is provided to first main face 15a of metal plate 15. A portion of first main face 15a of side-facing negative electrode 18 exposed from resin sealing body 20 when viewed in the stacking direction configures a terminal electrode face of power storage module 100.

Side-facing positive electrode 19 configures an end of electrode assembly 10 on the other side in the stacking direction. Side-facing positive electrode 19 includes metal plate 15 and positive electrode layer 16. Positive electrode layer 16 is provided to first main face 15a of metal plate 15. As for side-facing positive electrode 19, neither positive electrode layer 16 nor negative electrode layer 17 is provided to second main face 15b of metal plate 15. A portion of second main face 15b of side-facing positive electrode 19 exposed from resin sealing body 20 when viewed in the stacking direction configures a terminal electrode face of power storage module 100.

Positive electrode layer 16 is formed by applying a positive electrode active material to first main face 15a. Negative electrode layer 17 is formed by applying a negative electrode active material to second main face 15b.

When power storage module 100 is a nickel-hydride secondary battery and/or the like, nickel hydroxide, for example, may be used as the positive electrode active material, and a hydrogen storage alloy, for example, may be used as the negative electrode active material.

When power storage module 100 is a lithium-ion secondary battery, as the positive electrode active material, those capable of occluding and releasing electric charge carriers such as lithium ions may be used, for example. Specifically, as the positive electrode active material, those which can be used as a positive electrode active material of a lithium-ion secondary battery, such as a lithium-ion composite metal oxide of lamellar rock salt structure, a metal oxide of spinel structure, and/or a polyanion-based compound, may be used. Two or more positive electrode active materials may be used concurrently, and, for example, the positive electrode active material may include olivine-type lithium iron phosphate (LiFePO₄).

When power storage module 100 is a lithium-ion secondary battery, as the negative electrode active material, lithium, carbon, a metal compound, an element capable of forming alloy with lithium or a compound thereof, and the like may be used.

With regard to any of electrode plates 14, side-facing negative electrode 18, and side-facing positive electrode 19, the peripheral part of metal plate 15 is present as a non-coated region to which neither positive electrode layer 16 nor negative electrode layer 17 is provided.

Each electrode plate 14 is provided with a terminal member 30 which protrudes from resin sealing body 20. Terminal member 30 is connected to the above-described non-coated region. Specifically, one end of terminal member 30 overlapping the non-coated region (one end closer to electrode plate 14) is bonded to the non-coated region by ultrasonic welding, laser beam welding, or the like, to form a one-piece component. By this, terminal member 30 and metal plate 15 are electrically connected to each other.

To terminal member 30, as one or more through holes, a plurality of slits 31 are provided. More specifically, to at least a portion of terminal member 30 protruding from resin sealing body 20, slits 31 are provided. Although a plurality of slits 31 are provided in the present embodiment, terminal member 30 may be provided with only one through hole, as described below.

Electrode plates 14 are stacked in one direction, in such a manner that positive electrode layer 16 is positioned on one side in the stacking direction and negative electrode layer 17 is positioned on the other side in the stacking direction. By this, between electrode plates 14 adjacent to each other in the stacking direction (more specifically, between metal plates 15 adjacent to each other in the stacking direction), a unit cell is formed.

Terminal member 30 is a voltage detection terminal for detecting voltage between two adjacent electrode plates 14 (the voltage of the above-mentioned unit cell). Terminal member 30 provided to one of two adjacent electrode plates 14 and terminal member 30 provided to the other one of the two adjacent electrode plates 14 are positioned in such a manner that overlapping is avoided when viewed in the stacking direction.

Slits 31 extend along the protruding direction in which terminal member 30 protrudes from electrode assembly 10 when viewed in the stacking direction. Slits 31 are aligned in a direction crossing the protruding direction (more specifically, in a direction orthogonal to the protruding direction), at regular intervals. Slits 31 have a predetermined width in a direction crossing the protruding direction.

Each slit 31 has a first end 31a and a second end 31b in a direction parallel to the protruding direction. First end 31a is an end located on the front edge side in the protruding direction. Second end 31b is an end located on the electrode assembly 10 side in the protruding direction. Second end 31b of each slit 31 is embedded inside resin sealing body 20.

To the outer side of resin sealing body 20, an outer-side sealing body (not shown) may be provided. The outer-side sealing body is formed by injection molding and/or the like, for example. The outer-side sealing body is made of a resin member. In this case, slits 31 located on the outer side of resin sealing body 20 may be buried inside the outer-side sealing body.

Resin sealing body 20 is provided so as to seal the periphery of electrode assembly 10. Specifically, resin sealing body 20 seals an internal space formed between two adjacent electrode plates 14. The internal space contains an electrolyte solution injected thereinto. Resin sealing body 20 is formed by curing a resin member such as a hot-melt member, a thermoplastic resin, a thermosetting resin, a photosetting resin, or the like.

Resin sealing body 20 has a rectangular cylindrical shape, and has a first side wall portion 21 and a second side wall portion 22, respectively, on both sides in a direction orthogonal to the stacking direction. The plurality of terminal members 30 protrude from first side wall portion 21 toward outside.

Second side wall portion 22 is provided with a plurality of inlet sealing portions 41 and a guide portion 42. Inlet sealing portions 41 seal a plurality of inlets. Each inlet communicates with the internal space formed between two adjacent electrode plates 14, and, after the electrolyte solution is injected through the inlet, it is sealed by inlet sealing portion 41.

An example of the arrangement of the inlets (inlet sealing portions 41) is that multiple sets of inlets, where the inlets in each set are aligned side by side but their positions in the stacking direction are different from each other, are aligned in the stacking direction.

Guide portion 42 is provided so as to surround the inlets. Guide portion 42 is formed by, for example, placing frame-shaped portions surrounding the inlets placed in a matrix. For example, guide portion 42 may be formed by fixing a member different from resin sealing body 20 formed in advance as guide portion 42, to an outer surface 22a of second side wall portion 22. Guide portion 42 may be formed on outer surface 22a by injection molding of a resin member.

Guide portion 42 inhibits leakage of the electrolyte solution from each frame-shaped portion toward outside at the time when the electrolyte solution is injected into the internal space. In addition, guide portion 42 guides the electrolyte solution into the inlet.

Although the above description is about an example configuration where the plurality of inlet sealing portions 41 and guide portion 42 are provided to second side wall portion 22, this is not limitative; these may be provided to first side wall portion 21 or to a side wall portion other than first side wall portion 21 or second side wall portion 22.

(Production Method)

FIG. 5 is a flowchart of a production procedure for the power storage module according to Embodiment 1. With reference to FIG. 5, a method of producing power storage module 100 is described.

As shown in FIG. 5, for producing power storage module 100, firstly in step (S1), electrode plates 14 are prepared. Specifically, a plurality of metal plates 15 are prepared where first main face 15a is provided with positive electrode layer 16, second main face 15b is provided with negative electrode layer 17, and one end of terminal member 30 (an end closer to electrode plate 14) is connected to the non-coated region. The one end of terminal member 30 is bonded to the non-coated region by ultrasonic welding, laser beam welding, or the like.

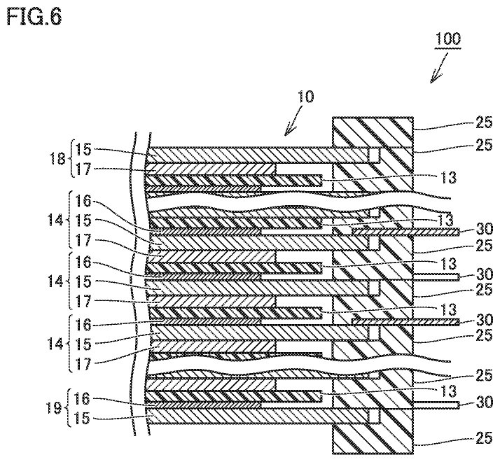

Then, in step (S10), a resin member 25 (see FIG. 6) is placed, which is a precursor of resin sealing body 20. Specifically, resin member 25 is placed which is for sealing the internal space formed between two adjacent electrode plates 14 inside electrode assembly 10 including electrode plates 14 stacked in the stacking direction. Specifically, the one end of resin member 25 (an end closer to electrode plate 14) may be bonded to the above-described non-coated region by heat sealing and/or the like, for example. Step (S10) may include step (S11) and step (S12).

FIG. 6 is a schematic cross-sectional view of a step, in the production procedure shown in FIG. 5, to place a resin member in such a manner that the terminal member protrudes from the resin member.

As shown in FIG. 5 and FIG. 6, in step (S11), resin member 25 is placed in such a manner that terminal member 30, as a protruding portion, protrudes from resin member 25. Specifically, when a thermoplastic resin, a thermosetting resin, or a hot-melt member is used as resin member 25, for example, electrode plates 14 having a sheet-form resin member 25 placed on the peripheral part of metal plate 15 (the non-coated region) are stacked in such a manner that terminal member 30 protrudes. Placing resin member 25 may be carried out by bonding one end of resin member 25 to the non-coated region as described above, and, in this case, electrode plates 14 having terminal member 30 and resin member 25 bonded thereto are stacked in the stacking direction.

In a state where resin member 25 is placed, the front edge of terminal member in a direction parallel to the protruding direction is located outside the resin member and the root of terminal member 30 in the direction parallel to the protruding direction (the end closer to electrode plate 14) is covered with resin member 25 and connected to metal plate 15. As described above, terminal member 30 is provided with slits 31, and second end 31b of each slit 31 overlaps resin member 25 in the stacking direction.

When a photosetting resin (more specifically, an ultraviolet-curable resin) and/or the like is used as resin member 25, resin member 25 may be applied to the side surface of electrode assembly 10 which is formed of staking of electrode plates 14, in such a manner that terminal member 30 protrudes from electrode assembly 10.

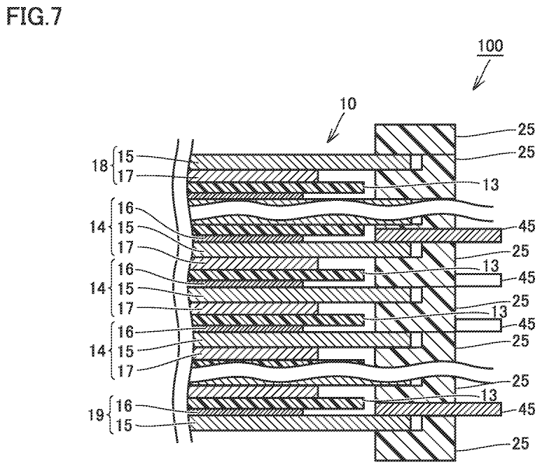

FIG. 7 is a schematic cross-sectional view of a step, in the production procedure shown in FIG. 5, to place a resin member in such a manner that an inlet-forming jig protrudes from the resin member.

As shown in FIG. 5 and FIG. 7, in step (S12), resin member 25 is placed in such a manner that an inlet-forming jig 45 as a protruding portion protrudes from resin member 25. Specifically, when a thermoplastic resin, a thermosetting resin, or a hot-melt member is used as resin member 25, for example, electrode plates 14 having a sheet-form resin member 25 placed on the peripheral part of metal plate 15 are stacked in such a manner that inlet-forming jig 45 protrudes. Placing resin member 25 may be carried out by bonding one end of resin member 25 to the non-coated region as described above, and, in this case, electrode plates 14 are stacked in the stacking direction, with inlet-forming jig 45 placed at a predetermined position and inlet-forming jig 45 sandwiched between resin member 25 and metal plate 15.

Inlet-forming jig 45 is a flat plate, for example. In a state where resin member is placed, the front edge side of inlet-forming jig 45 in the direction parallel to the protruding direction is located outside the resin member 25, and the root side of inlet-forming jig 45 in the direction parallel to the protruding direction (the end closer to electrode plate 14) overlaps metal plate 15 in the stacking direction. More specifically, the root side of inlet-forming jig 45 is exposed into the internal space formed between two adjacent electrode plates 14.

Inlet-forming jig 45 is placed between two adjacent electrode plates 14. A plurality of inlet-forming jigs 45 are placed at positions corresponding to the positions at which a plurality of inlets are to be formed. Specifically, multiple sets of inlet-forming jigs, where the inlet-forming jigs in each set are aligned side by side but their positions in the stacking direction are different from each other, are placed in alignment in the stacking direction.

Similarly to the case of terminal member 30, inlet-forming jig 45 is also provided with a plurality of slits as one or more through holes.

When a photosetting resin (more specifically, an ultraviolet-curable resin) and/or the like is used as resin member 25, resin member 25 may be applied to the side surface of electrode assembly 10 which is formed of staking of metal plates 15, in such a manner that inlet-forming jig 45 protrudes.

Next, as shown in FIG. 5, step (S20) is carried out. In step (S20), resin sealing body 20 is formed by welding or curing resin member 25. Specifically, infrared light or ultraviolet light is applied toward resin member 25 from an irradiation apparatus 80 which is placed facing resin member 25 in the protruding direction in which the protruding portion protrudes when viewed in the stacking direction.

As described above, when resin member 25 is a thermoplastic resin, a thermosetting resin, or a hot-melt member, resin member 25 is irradiated with infrared light, and when resin member 25 is an ultraviolet-curable resin, resin member 25 is irradiated with ultraviolet light. A plurality of resin members 25 which have been irradiated with infrared light or ultraviolet light are welded or cured to each other to be made into a one-piece component, and thereby resin sealing body 20 is formed. Step (S20) may include step (S21) and step (S22).

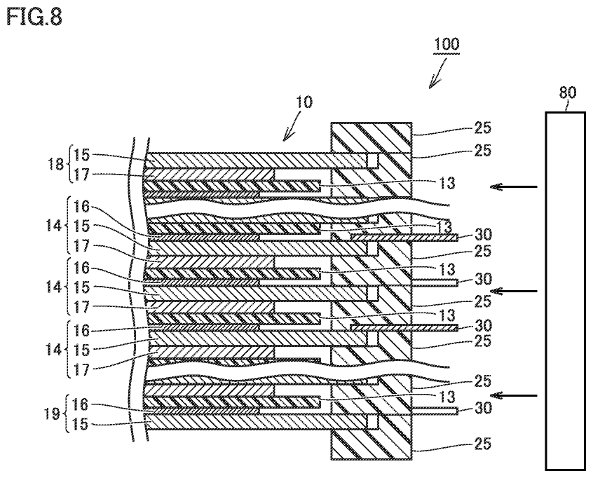

FIG. 8 is a schematic cross-sectional view of a step, in the production procedure shown in FIG. 5, to apply infrared light or ultraviolet light toward the resin member that is placed in such a manner that the terminal member protrudes from it.

As shown in FIG. 5 and FIG. 8, in step (S21), infrared light or ultraviolet light is applied toward resin member 25 from which terminal member 30 protrudes. Specifically, as described above, infrared light or ultraviolet light is applied toward resin member 25 along the direction parallel to the protruding direction in which terminal member 30 protrudes when viewed in the stacking direction. For example, infrared light or ultraviolet light is applied toward resin member 25 from irradiation apparatus 80 which is placed facing resin member 25.

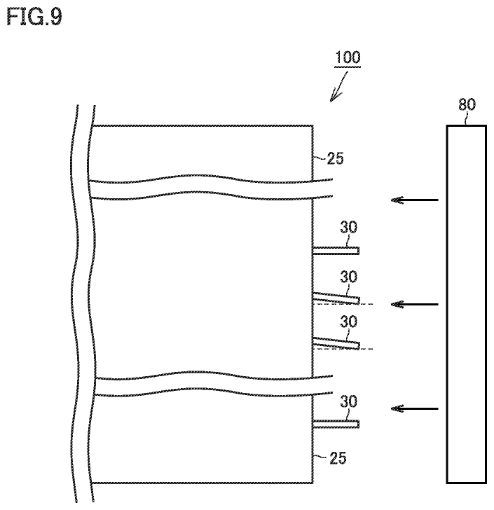

FIG. 9 is a schematic view of the application step shown in FIG. 7 when the terminal member is tilted.

Generally, when terminal member 30 is tilted and slits 31 are not provided, it is difficult to irradiate a portion of resin member 25 that is positioned in a region overlapping terminal member 30 in the direction parallel to the protruding direction, with ultraviolet light or infrared light.

In the present embodiment, terminal member 30 is provided with slits 31. As a result, through slits 31, it is possible to irradiate resin member 25 with infrared light or ultraviolet light.

By this, as compared to when terminal member 30 is not provided with a through hole, such as a slit, even at a region overlapping the tilted terminal member 30, it is possible to facilitate welding or curing of resin member 25. By this, it is possible to form resin sealing body 20 with reduced areas of poor welding or poor curing of resin member 25, consequently allowing for reducing failures in sealing with resin sealing body 20.

At this time, when second end 31b of each slit 31 overlaps resin member 25 in the stacking direction (when it is embedded inside resin member 25), infrared light or ultraviolet light can be applied toward inside resin member 25 through slits 31. By this, it is possible to further reduce areas of poor welding or poor curing of resin member 25, consequently allowing for further reducing failures in sealing with resin sealing body 20.

In addition, when a thermoplastic resin, a thermosetting resin, a hot-melt member, or the like is used as resin member 25 and resin member 25 is welded with infrared light for forming resin sealing body 20, the slit width of slits 31 may be twice the wavelength of the infrared light or less.

At the time of applying infrared light, the wavelength of the infrared light that is applied is selected from the absorption wavelengths that are optimum for welding the material of resin member 25. When the slit width is twice the wavelength of infrared light or less, due to the effect of diffraction, it is possible to irradiate a larger area of resin member 25 with infrared light, allowing for further reducing failures in sealing with resin sealing body 20.

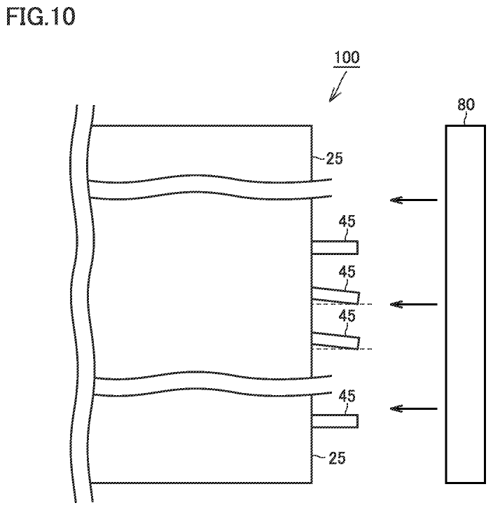

FIG. 10 is a schematic cross-sectional view of a step, in the production procedure shown in FIG. 5, to apply infrared light or ultraviolet light toward the resin member that is placed in such a manner that the inlet-forming jig protrudes from it.

As shown in FIG. 5 and FIG. 10, in step (S22), infrared light or ultraviolet light is applied toward resin member 25 from which inlet-forming jig 45 protrudes. Specifically, as described above, infrared light or ultraviolet light is applied toward resin member 25 along the direction parallel to the protruding direction in which inlet-forming jig 45 protrudes when viewed in the stacking direction. For example, infrared light or ultraviolet light is applied toward resin member 25 from irradiation apparatus which is placed facing resin member 25.

Even when inlet-forming jig 45 is tilted as illustrated in FIG. 10, slits 31 that are provided to inlet-forming jig 45 make it possible to irradiate even a region of resin member 25 overlapping the tilted inlet-forming jig 45, with infrared light or ultraviolet light, in the same way as described above. By this, it is possible to facilitate welding or curing of resin member 25 in such a region, allowing for reducing failures in sealing with resin sealing body 20.

Also in this case, second end 31b of each slit 31 provided to inlet-forming jig 45 may overlap resin member 25 in the stacking direction, and the slit width of slits 31 may be twice a wavelength of infrared light or less.

Subsequently, as shown in FIG. 5, step (S30) is carried out. In step (S30), an electrolyte solution is injected. Specifically, firstly, inlet-forming jig 45 is pulled out from resin sealing body 20 to form an inlet. Subsequently, guide portion 42 as mentioned above is formed. As described above, guide portion 42 may be formed by fixing a member different from resin sealing body 20 formed in advance as guide portion 42, to outer surface 22a of second side wall portion 22, or may be formed on outer surface 22a by injection molding of a resin member.

Subsequently, the electrolyte solution is injected through the inlet into the above-described internal space, and the inlet is sealed with inlet sealing portion 41.

By the above-described steps, power storage module 100 according to Embodiment 1 can be produced.

(First Modification)

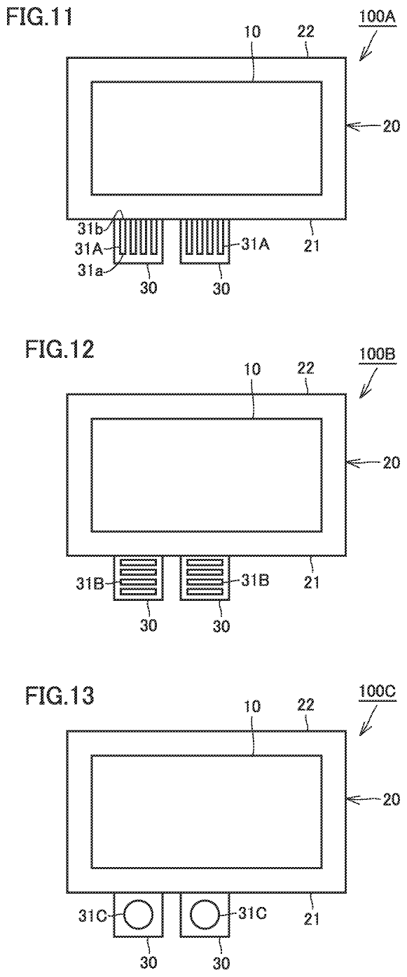

FIG. 11 is a plan view of a power storage module according to a first modification. With reference to FIG. 11, a power storage module 100A according to a first modification will be described.

As illustrated in FIG. 11, power storage module 100A according to the first modification is different from power storage module 100 according to Embodiment 1 in the position of second end 31b of a slit 31A provided to terminal member 30.

Second end 31b is not embedded inside resin sealing body 20, but, instead, it is located at the same position as the outer surface of resin sealing body 20 or outside resin sealing body 20 when viewed in the stacking direction. In this way, the position of second end 31b may be changed. Power storage module 100A according to the first modification may be produced by the production method according to Embodiment 1. In the first modification, in step (S11) described above, resin member is placed in such a manner that second end 31b does not overlap resin member 25 in the stacking direction.

(Second Modification)

FIG. 12 is a plan view of a power storage module according to a second modification. With reference to FIG. 12, a power storage module 100B according to the second modification will be described.

As illustrated in FIG. 12, power storage module 100B according to the second modification is different from power storage module 100 according to Embodiment 1 in the extending direction of slits 31B provided to terminal member 30.

Slits 31B extend along a lateral direction which is orthogonal to the stacking direction and to the protruding direction. Slits 31B are aligned along the protruding direction when viewed in the stacking direction. Even when slits 31B are provided in this way, power storage module 100B according to the second modification can be produced by the production method according to Embodiment 1.

(Third Modification)

FIG. 13 is a plan view of a power storage module according to a third modification. With reference to FIG. 13, a power storage module 100C according to the third modification will be described.

As illustrated in FIG. 13, power storage module 100C according to the third modification is different from power storage module 100 according to Embodiment 1 in that, in the former, a single through hole 31C is provided to terminal member 30. An example of the shape of through hole 31C is circular, but the shape of through hole 31C is not limited to circular and may be selected as appropriate from rectangular, polygonal, oval, and the like. Even when through hole 31C is provided in this way, power storage module 100C according to the third modification can be produced by the production method according to Embodiment 1.

(Fourth Modification)

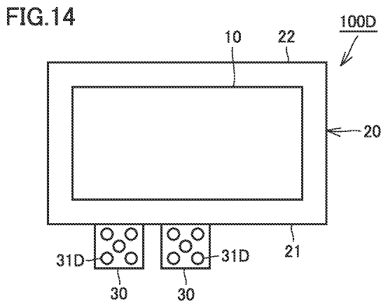

FIG. 14 is a plan view of a power storage module according to a fourth modification. With reference to FIG. 14, a power storage module 100D according to the fourth modification will be described.

As illustrated in FIG. 14, power storage module 100D according to the fourth modification is different from power storage module 100 according to Embodiment 1 in that, in the former, a plurality of through holes 31D are provided to terminal member 30. The plurality of through holes 31D may be provided in matrix, or may be provided at random. The shape of through hole 31D may be selected as appropriate, as in the third modification. Even when through holes 31D are provided in this way, power storage module 100D according to the fourth modification can be produced by the production method according to Embodiment 1.

### Embodiment 2

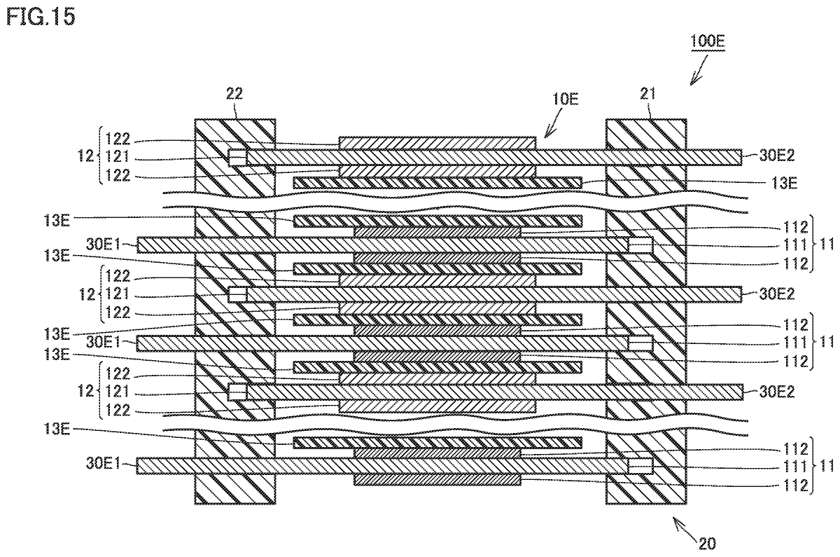

FIG. 15 is a cross-sectional view of a power storage module according to Embodiment 2. With reference to FIG. 15, a power storage module 100E according to Embodiment 2 will be described.

As illustrated in FIG. 15, power storage module 100E according to Embodiment 2 is different from power storage module 100 according to Embodiment 1, mainly in the configuration of an electrode assembly 10E. The other configuration is substantially the same. Power storage module 100E is configured in the form of an all-solid-state battery.

Electrode assembly 10E includes a plurality of positive electrode plates 11 and a plurality of negative electrode plates 12 as a plurality of electrode plates, as well as a plurality of solid electrolyte layers 13E. The plurality of positive electrode plates 11 and the plurality of negative electrode plates 12 are stacked alternately, with solid electrolyte layer 13E sandwiched between them.

Positive electrode plate 11 includes a metal plate 111 and a positive electrode layer 112. For example, positive electrode layer 112 is formed on both sides of metal plate 111.

Metal plate 111 is provided with a protruding terminal member 30E1. Protruding terminal member 30E1 is formed as a one-piece component with metal plate 111. Protruding terminal member 30E1 is provided so as to protrude from resin sealing body 20 toward outside. Protruding terminal member 30E1 protrudes from first side wall portion 21 of resin sealing body 20, toward outside.

As metal plate 111, metal foil such as SUS foil, Ni foil, Cr foil, Al foil, Pt foil, N foil, Fe foil, Ti foil, and/or Zn foil can be used, for example.

Positive electrode layer 112 includes a positive electrode active material. As the positive electrode active material, a known positive electrode active material, typically lithium cobalt oxide and/or the like, can be used as appropriate, for example. Positive electrode layer 112 may include a solid electrolyte. In such a case, as the solid electrolyte, any solid electrolyte such as sulfide-based solid electrolyte and/or oxide electrolyte can be used.

Negative electrode plate 12 includes a metal plate 121 and a negative electrode layer 122. For example, negative electrode layer 122 is formed on both sides of metal plate 121.

Metal plate 121 is provided with a protruding terminal member 30E2. Protruding terminal member 30E2 is formed as a one-piece component with metal plate 121. Protruding terminal member 30E2 is provided so as to protrude from resin sealing body 20 toward outside. Protruding terminal member 30E2 protrudes from second side wall portion 22 of resin sealing body 20, toward outside.

Protruding terminal member 30E2 may protrude from first side wall portion 21 of resin sealing body 20, toward outside. In such a case, in some embodiments, protruding terminal member 30E2 is positioned so that it does not overlap protruding terminal member 30E1 in the stacking direction.

As metal plate 121, metal foil such as SUS foil, Cu foil, Ni foil, Fe foil, Ti foil, Co foil, and/or Zn foil can be used.

Negative electrode layer 122 includes a negative electrode active material. As the negative electrode active material, a known carbon-based negative electrode composite material such as graphite can be used, for example. The negative electrode active material is not limited to graphite, and other known negative electrode active materials can be used as appropriate. Negative electrode layer 122 may include a solid electrolyte. In such a case, as the solid electrolyte, any solid electrolyte such as sulfide-based solid electrolyte and/or oxide electrolyte can be used.

Solid electrolyte layer 13E is interposed between positive electrode layer 112 and negative electrode layer 122. The solid electrolyte contained in solid electrolyte layer 13E is not particularly limited provided that it is a known solid electrolyte usable for batteries, and may be the same solid electrolyte as used in negative electrode layer 122.

Also in Embodiment 2, each of protruding terminal members 30E1, 30E2 is provided with a plurality of slits (not shown) as one or more through holes, as in Embodiment 1.

Power storage module 100E according to Embodiment 2 can also be produced by the production method according to Embodiment 1. In power storage module 100E according to Embodiment 2 where no electrolyte solution is required, it is possible to omit the steps to form an inlet and inject electrolyte solution into the internal space through the inlet.

Also in Embodiment 2, even when protruding terminal members 30E1, 30E2 are tilted at the time of applying infrared light or ultraviolet light to the resin member which is a precursor of resin sealing body 20, the plurality of slits provided to each of protruding terminal members 30E1, 30E2 make it possible to irradiate even a region of the resin member overlapping the tilted protruding terminal members 30E1, 30E2, with infrared light or ultraviolet light. By this, it is possible to facilitate welding or curing of resin member 25 in such a region, allowing for reducing failures in sealing with resin sealing body 20.

Although Embodiment 2 is described with an internal space formed between metal plate 111 and metal plate 121 adjacent to each other, this is not limitative; the internal space may be filled with resin sealing body 20.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A power storage module comprising:
an electrode assembly including a plurality of electrode plates stacked in a stacking direction;
a resin sealing body for sealing an internal space formed between two adjacent electrode plates of the plurality of electrode plates; and
a terminal member provided to each of the plurality of electrode plates so as to protrude from the resin sealing body toward outside, wherein
a portion of the terminal member protruding from the resin sealing body is provided with one or more through holes penetrating along the stacking direction.

2. The power storage module according to claim 1, wherein the one or more through holes are configured in the form of a plurality of slits.

3. The power storage module according to claim 2, wherein the plurality of slits, when viewed in the stacking direction, are aligned either in a protruding direction in which the terminal member protrudes from the resin sealing body, or in a direction crossing the protruding direction.

4. The power storage module according to claim 2, wherein
the plurality of slits are provided so as to, when viewed in the stacking direction, extend along a protruding direction in which the terminal member protrudes from the resin sealing body and also be aligned in a direction crossing the protruding direction, and
each end of the plurality of slits that is located closer to the electrode assembly in the protruding direction is embedded inside the resin sealing body.

5. The power storage module according to claim 2, wherein a slit width of each of the plurality of slits is twice a wavelength of infrared light or less.

6. The power storage module according to claim 1, wherein
the electrode plate is a bipolar electrode, and
the terminal member is a voltage detection terminal for detecting voltage between the two adjacent electrode plates.

7. The power storage module according to claim 6, wherein the voltage detection terminal provided to one of the two adjacent electrode plates and the voltage detection terminal provided to the other one of the two adjacent electrode plates are positioned in such a manner that overlapping is avoided when viewed in the stacking direction.

8. A method of producing a power storage module, the method comprising:
placing a resin member for sealing an internal space formed between two adjacent electrode plates inside an electrode assembly including a plurality of electrode plates stacked in a stacking direction; and
forming a resin sealing body by welding or curing the resin member, wherein
the placing a resin member includes placing the resin member in such a manner that a protruding portion provided with one or more through holes penetrating along the stacking direction protrudes from the resin member toward outside, and
the forming a resin sealing body includes applying infrared light or ultraviolet light toward the resin member along a direction parallel to a protruding direction in which the protruding portion protrudes when viewed in the stacking direction.

9. The method of producing a power storage module according to claim 8, wherein the protruding portion includes a terminal member provided to each of the plurality of electrode plates.

10. The method of producing a power storage module according to claim 9, wherein
the electrode plate is a bipolar electrode, and
the terminal member is a voltage detection terminal for detecting voltage between the two adjacent electrode plates.

11. The method of producing a power storage module according to claim 8, wherein the protruding portion includes an inlet-forming jig located between the two adjacent electrode plates for forming an inlet from which an electrolyte solution is to be injected into the internal space.
